(19) United States
(12) Patent Application Publication
(10) Pub. No.: US 2024/0400779 A1
(43) Pub. Date: Dec. 5, 2024

(54) SILICONE FOAM COMPOSITION

(71) Applicants: DOW GLOBAL TECHNOLOGIES LLC, Midland, MI (US); DOW SILICONES CORPORATION, Midland, MI (US)

(72) Inventors: Shuqi LAI, Midland, MI (US); Jody J. HENNING, Midland, MI (US); Yanhu WEI, Midland, MI (US); Kshitish A. PATANKAR, Midland, MI (US); Mark F. SONNENSCHEIN, Midland, MI (US)

(21) Appl. No.: 18/580,565

(22) PCT Filed: Jul. 18, 2022
(86) PCT No.: PCT/US2022/037411

§ 371 Date: Jan. 18, 2024

Related U.S. Application Data
(60) Provisional application No. 63/223,568, filed on Jul. 20, 2021.

(51) Int. Cl. C08J 9/00; C08G 77/08; C08G 77/14; C08G 101/00; C08J 9/14; C08J 9/30

(52) U.S. Cl. CPC C08J 9/0047; C08G 77/08; C08G 77/14; C08J 9/0019; C08J 9/0042; C08J 9/146; C08J 9/30; C08G 2101/00; C08G 2110/0041; C08J 2383/06

(57) ABSTRACT

Silicone foam compositions for forming foamed silicone elastomers are described herein, together with the respective foamed silicone elastomers formed therefrom and to methods of making such compositions and foamed silicone elastomers. The silicone rubber foam composition comprising: (a) one or more organopolysiloxane polymers having an average of at least two epoxide groups per molecule; (b) a Lewis acid catalyst, (c) one or more surfactants and optionally (d) a physical blowing agent. The foamed silicone elastomers are prepared by either mechanically foaming components (a), (b) and (c); or by introducing a physical blowing agent (d); and causing foaming by physical blowing.

This disclosure relates to silicone foam compositions for forming foamed silicone elastomers, the respective foamed silicone elastomers formed therefrom and to methods of making such compositions and foamed silicone elastomers.

Foamed silicone elastomers are used in a wide range of applications such as for joint sealants, insulators and mechanical shock absorbers because of a variety of beneficial physical properties, not least thermal stability, low flammability and electrical resistance.

Room temperature vulcanization (RTV) silicone foams are almost exclusively provided as two-part compositions, which after mixing, are designed to cure with simultaneous gas generation which causes the resulting mixture to foam during the cure process. Usually, the gas produced is hydrogen, being a product of a catalysed dehydrocondensation reaction between compounds having silicon bonded hydrogen (Si—H) groups and hydroxyl-functional components. Originally, the reaction which took place was between a silicone polymer having an average of two or more —OH groups and a silicone polymer having an average of two or more silicon bonded hydrogen (Si—H) groups catalysed with a tin catalyst. This resulted in the formation of Si—O—Si bonds and the release of hydrogen gas (i.e., a chemical foaming agent) which caused foaming. However, this process became unpopular because some of the preferred catalysts were believed to have undesirable toxic effects.

Increasingly therefore, the majority of current RTV silicone foam compositions are now prepared utilizing expensive platinum group metal-based catalysts, mainly platinum-based catalysts, that catalyze both the hydrosilylation cure process of the composition and/or a dehydrocondensation reaction process between compounds containing Si—H groups and compounds containing —OH groups, again generating hydrogen gas which is consequently used as the means of foaming the composition.

Whilst this platinum group cured process works well, disadvantages remain. The platinum group catalysts are expensive and materials cured by such catalysts can suffer from discoloration and the formation of colloidal platinum particles over time. Such catalysts can have additional problems as they can be poisoned in the presence of impurities, such as nitrogen and sulfur-containing heterocyclics.

Furthermore, the continued reliance on flammable hydrogen gas in the foaming process, raises potential safety concerns for users because, for example, the presence of hydrogen gas at concentrations between the lower and upper explosion limits (LEL and UEL) in an environment where sparks and/or high heat exist is potentially hazardous.

Efforts have been made to identify alternative routes to generate silicone foams. For example, John. B Grande et al. in Polymer 53 (2012) p. 3135-3142, reported the generation of silicone foams by means of a Pierse-Rubinsztajn reaction by reacting an Si—H terminated polydimethylsiloxane with an alkoxysilane crosslinker such as tetraethyl orthosilicate catalysed using an organo-borane catalyst, tris(pentafluorophenyl)borane (B(C₆F₅)₃). Alkane gases were generated and utilised as the blowing agents instead of hydrogen. More recently, WO2020/028299 describes a process substantially relying on the use of physical blowing agents as an alternative to chemical blowing agents which generate hydrogen. However, WO2020/028299 still relies on expensive and potentially problematic platinum catalysts for curing the composition.

In view of the foregoing, there remains an opportunity to provide improved compositions for forming foamed silicone elastomers. There also remains an opportunity to provide improved foamed silicone elastomers, and improved methods of forming such compositions and foams.

There is provided a silicone rubber foam composition comprising:
(a) one or more organopolysiloxane polymers having an average of at least two epoxide groups per molecule;
(b) a Lewis acid catalyst;
(c) one or more surfactants; and optionally
(d) a physical blowing agent.

There is also provided a method of making a silicone rubber foam comprising:

mixing a silicone rubber foam composition comprising
(a) one or more organopolysiloxane polymers having an average of at least two epoxide groups per molecule;
(b) a Lewis acid catalyst;
(c) one or more surfactants; and
   either mechanically foaming the above composition; or
   introducing (d) a physical blowing agent; and causing foaming by means of said physical blowing agent (d),
   in each case whilst the composition cures.

There is also provided a silicone rubber foam which is a foamed and cured product of the above composition.

It was found that the addition of a surfactant in the composition described above resulted in foams prepared using such compositions having much better cellular structure. Furthermore, as discussed above, the present composition does not rely on the use of expensive platinum-based catalysts and hydrosilylation cure processes which avoids consequential high costs involved in using such catalysts but also avoids discoloration and formation of colloidal platinum particles over time.

Furthermore, the catalysts used do not appear to be poisoned in the presence of impurities, such as nitrogen and sulfur-containing heterocyclics unlike platinum catalysts.

The composition used herein contains the following components:

### Component (a): One or More Organopolysiloxanes Having an Average of at Least Two Epoxide Groups Per Molecule

Organopolysiloxanes contain multiple siloxane linkages and can be characterized by the siloxy (SiO) groups that make up the polysiloxane. Siloxy groups are M-type, D-type, T-type or Q-type. M-type siloxy groups can be written as ≡SiO_{1/2} where there are three groups bound to the silicon atom in addition to an oxygen atom that is shared with another atom linked to the siloxy group. D-type siloxy groups can be written as ═SiO_{2/2} where there are two groups bound to the silicon atom in addition to two oxygen atoms that are shared with other atoms linked to the siloxy group. T-type siloxy groups can be written as —SiO_{3/2} where one group is bound to the silicon atom in addition to three oxygen atoms that are shared with other atoms linked to the siloxy group. Q-type siloxy groups can be written as SiO_{4/2} where the silicon atom is bound to four oxygen atoms that are shared with other atoms linked to the siloxy group. The groups bound to the organopolysiloxane polymers having an average of at least two epoxide groups per molecule (a) other than said epoxide groups may be independently selected from aliphatic hydrocarbyl, aromatic hydrocarbyl, or organyl group (that is any organic substituent group, regardless of functional type, having one free valence at a carbon atom) excluding epoxide groups. Saturated aliphatic hydrocarbyls are exemplified by, but not limited to alkyl groups monovalent saturated hydrocarbon groups, which typically contain from 1 to 20 carbon atoms, such as methyl, ethyl, propyl, pentyl, octyl, undecyl, and octadecyl and cycloalkyl groups such as cyclohexyl. Unsaturated aliphatic hydrocarbyls are exemplified by alkenyl groups having from 2 to 10 carbon atoms, such as vinyl, allyl, butenyl, pentenyl, isopropenyl, 5-hexenyl, cyclohexenyl and hexenyl; and by alkynyl groups. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups such as chloromethyl and 3-chloropropyl; nitrogen containing groups such as amino groups, amido groups, imino groups, imido groups; oxygen containing groups such as polyoxyalkylene groups, carbonyl groups, alkoxy groups and hydroxyl groups.

The molecular structure of organopolysiloxane polymer (a) is typically linear, however, there can be some branching due to the presence of T groups (as previously described) within the molecule. Component (a) may have any suitable viscosity of from 40 mPa·s to 500,000 mPa·s at 25° C., alternatively from 200 mPa·s to 150,000 mPa·s at 25° C., alternatively from 200 mPa·s to 125,000 mPa·s at 25° C., alternatively from 200 mPa·s to 100,000 mPa·s at 25° C. alternatively from 200 mPa·s to 80,000 mPa·s measured at 25° C. relying on the cup/spindle method of ASTM D1084-16 Method B, using an appropriate spindle for the viscosity range unless otherwise indicated. The one or more organopolysiloxane polymers having an average of at least two epoxide groups per molecule (a) may be selected from polydimethylsiloxanes, alkylmethylpolysiloxanes, alkylarylpolysiloxanes or copolymers thereof containing e.g. alkenyl and/or alkynyl groups and may have any suitable terminal groups, for example, they may be trialkyl terminated, alkenyldialkyl terminated or may be terminated with any other suitable terminal group combination providing each organopolysiloxane polymer (a) contains an average of at least two epoxide groups per molecule.

The one or more organopolysiloxanes having an average of at least two epoxide groups per molecule (a) can include one or more than one epoxide groups, providing there is an average of at least two epoxide groups per molecule.

An epoxide group is a cyclic ether with a three membered ring consisting of an oxygen atom bonded to two carbon atoms that are already bonded in some way. Any suitable epoxide group may be utilised such as an alpha-epoxide group which is a three-member ring structure (oxirane ring) or a cycloaliphatic epoxide which comprises one or more aliphatic rings in a molecule on which the oxirane ring is contained.

When present an alpha-epoxide group is linked to a silicon atom of the organopolysiloxane(s) by way of an alkylene chain or a substituted alkylene chain comprising an optional ether linkage.

Henceforth this shall be referred to herein as an “alpha-epoxide chain”.

Alternatively, the epoxide group may be a cycloaliphatic epoxide which comprises one or more aliphatic rings in the molecule on which the oxirane ring is contained. When present a cycloaliphatic epoxide group is linked to a silicon atom of the organopolysiloxane(s) by way of an alkylene chain or a substituted alkylene chain comprising an optional ether linkage. Henceforth this shall be referred to herein as a “cycloaliphatic epoxide chain”.

Hence, using the D notation above, for the sake of this disclosure a “D^{EP}” unit is a D unit having an alpha-epoxide chain attached to the silicon, with the alpha-epoxide chain preferably having a terminal alpha-epoxide group. An example of a D^{EP} unit having an alkylene chain is shown below:

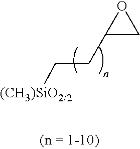

and an example of a D^{EP} unit having a substituted alkylene chain comprising an ether linkage is shown below:

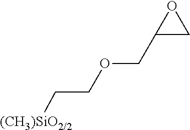

and consequently, it follows that M^{EP} is an M group containing two methyl groups and an analogous alpha-epoxide chain selected from the above.

Similarly, D^{EP} is a D siloxy unit where a cycloaliphatic epoxide chain is bonded to silicon with the cycloaliphatic epoxide chain preferably having a terminal cycloaliphatic epoxide group. For example, D^{HEP} is a D^{CEP} that is a D siloxy unit where one of the methyl groups is replaced with ethyl-cyclohexene oxide:

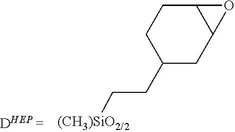

In this case, the cycloaliphatic epoxide chain comprises a cyclohexene oxide group. Consequently, it follows that an M^{HEP} group is as follows:

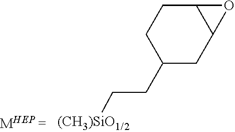

An organopolysiloxane having an average of at least two epoxide groups per molecule (a) may comprise both one or more alpha-epoxide chains and one or more cycloaliphatic epoxide chains but preferably comprises either alpha-epoxide chains or cycloaliphatic epoxide chains. In both alpha-epoxide chains and cycloaliphatic epoxide chains as described herein the alkylene chain or substituted alkylene chain comprising an ether linkage comprises up to 15 carbons, alternatively 11 carbons, alternatively up to 10 carbons, alternatively up to 6 carbon atoms, alternatively is an ethylene, propylene butylene or hexylene or an equivalent substituted alkylene chain comprising an ether linkage in the case of propylene butylene or hexylene.

Continuing using the M, D, T and Q notation, the one or more organopolysiloxanes having an average of at least two epoxide groups per molecule may comprise at least one of the following:—

MDₐD^{CEP}_{b}M or MDₐD^{EP}_{b}M

where subscript a is typically a value of from 10 to about 300, alternatively from 20 to about 250, alternatively from 30 to 250, alternatively 40 to 200. Subscript b is the average number of D^{CEP} siloxy units per molecule and is typically a value of from 1 to 100, providing there is an average of 2 or more epoxide groups per molecule, alternatively from 2 to 90 alternatively from 2 to 80, alternatively from 2 to 75, alternatively from 4 to 75, alternatively from 5 to 70;

M^{CEP}D_{c}M^{CEP} or M^{EP}D_{c}M^{EP}

where subscript c is the average number of D siloxy units per molecule and typically has a value of from 5 to 500, alternatively from 5 to 400, alternatively from 10 to 400, alternatively from 10 to 300, alternatively from 20 to 300; and/or

D^{EP}_{b}D_{c}T₂ or D^{CEP}_{b}D_{c}T₂

where subscripts b and c correspond to the average number of moles of the corresponding siloxy unit per molecule and are as defined above.

Typically, the concentration of the one or more organopolysiloxanes having an average of at least two epoxide groups per molecule is from 20 to 97 weight % (wt. %) of the composition, alternatively from 50 to 90 wt. % of the composition, alternatively from 70 to 90 wt. % of the composition.

The one or more organopolysiloxanes having an average of at least two epoxide groups per molecule may be obtained commercially, where available, or may be prepared by reacting an organopolysiloxane having two or more Si—H groups with a suitable organic compound comprising an epoxide group and an unsaturated group selected from an alkynyl group or alkenyl group, alternatively an alkenyl group, alternatively an alkenyl group having from 2 to 6 carbons, alternatively vinyl. The above two starting materials can be mixed together in the presence of a hydrosilylation catalyst and a suitable solvent if required and heated to reflux for a suitable period or until completion.

### Component (b): Lewis Acid Catalyst

The Lewis acid catalyst (b) is desirably selected from a group consisting of aluminum alkyls, aluminum aryls, arylboranes, arylboranes including triarylborane (including substituted aryl and triarylboranes such a tris(pentafluorophenyl)borane), boron halides, aluminum halides, gallium alkyls, gallium aryls, gallium halides, silylium cations and phosphonium cations. Examples of suitable aluminum alkyls include trimethylaluminum and triethylaluminum. Examples of suitable aluminum aryls include triphenyl aluminum and tris(pentafluorophenyl)aluminum. Examples of triarylboranes include those having the following formula:

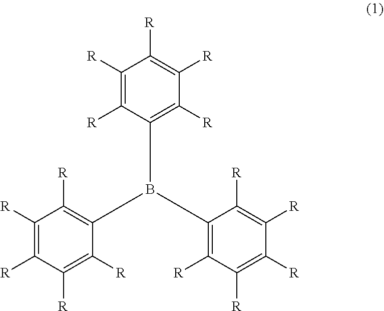

where each R in structure (1) above is independently in each occurrence selected from H, F, Cl and CF₃, a commercially available example being tris(pentafluorophenyl)borane (B(C₆F₅)₃). Examples of suitable boron halides include (CH₃CH₂)₂BCl and boron trifluoride. Examples of suitable aluminum halides include aluminum trichloride. Examples of suitable gallium alkyls include trimethyl gallium. Examples of suitable gallium aryls include tetraphenyl gallium. Examples of suitable gallium halides include trichlorogallium. Examples of suitable silylium cations include (CH₃CH₂)₃Si⁺X⁻ and Ph₃Si⁺X⁻. Examples of suitable phosphonium cations include F—P(C₆F₅)₃⁺X⁻. Preferably the Lewis acid catalyst (b) is selected from arylboranes, arylboranes including triarylborane (including substituted aryl and triarylboranes such a tris(pentafluorophenyl)borane) and/or boron halides. In particular Lewis acid catalyst (b) is selected from tris(pentafluorophenyl)borane (B(C₆F₅)₃), tris(3,5-bis(trifluoromethyl)phenyl)borane, bis(3,5-bis(trifluoromethyl)phenyl)(4-(trifluoromethyl)phenyl)borane, bis(3,5-bis(trifluoromethyl)phenyl)(2,4,6-trifluorophenyl)borane or a mixture thereof.

The Lewis acid catalyst (b) is typically present in the composition at a concentration of 10 weight parts per million (ppm) or more, 50 ppm or more, 150 ppm or more, 200 ppm or more, 250 ppm or more, 300 ppm or more, 350 ppm or more 400 ppm or more, 450 ppm or more, 500 ppm or more, 550 ppm or more, 600 ppm or more, 700 ppm or more 750 ppm or more, 1000 ppm or more 1500 ppm or more, 2000 ppm or more, 4000 ppm or more, 5000 ppm or more, even 7500 ppm or more, while at the same time is typically 10,000 or less, 7500 ppm or less, 5000 ppm or less, 1500 μm or less, 1000 ppm or less, or 750 ppm or less relative to the weight of the other ingredients/components in the composition.

The required amount of catalyst may be prepared by being dissolved in a suitable organic solvent such as in toluene and/or tetrahydrofuran (THF) and is then delivered to the composition in said solution. The chosen solvents evaporate out of the composition during or after the cure process.

### Component (c): One or More Surfactants

Any suitable surfactants (c) may be utilised in the composition herein.

The one or more surfactants (c) may comprise one or more anionic, non-ionic, amphoteric and/or cationic surfactants, and mixtures thereof.

Suitable surfactants (sometimes referred to as “foaming aids”) include silicone polyethers, ethylene oxide polymers, propylene oxide polymers, copolymers of ethylene oxide and propylene oxide, and combinations thereof. If/desired the composition comprises a fluorinated surfactant which may be organic or silicon containing such as perfluorinated polyethers i.e., those which have repeating units of the formulae:

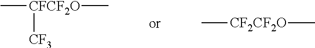

and mixtures of such units.

Alternatively, the fluorinated surfactant may be a silicon-containing fluorinated surfactant e.g., an organopolysiloxane which contain organic radicals having fluorine bonded thereto, such as siloxanes having repeating units of the formulae:

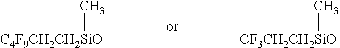

Adding the fluorinated surfactant to the composition herein may be utilised to decrease the cured foam density. In general, increasing the amount of fluorinated surfactant in the composition decreases the density of the foam. This is especially true for slow cure systems, where the surfactant stabilizes bubbles while the network forms and cures.

Anionic surfactants include alkali metal alkyl sulphates e.g. sodium lauryl sulfate; fatty alcohol ether sulfates (FAES); alkyl phenol ether sulfates (APES); carboxylic, phosphoric and sulfonic acids and their salt derivatives; alkyl carboxylates; acyl lactylates; alkyl ether carboxylates; n-acyl sarcosinate; n-acyl glutamates; fatty acid-polypeptide condensates; alkali metal sulforicinates; sulfonated glycerol esters of fatty acids, such as sulfonated monoglycerides of coconut oil acids; salts of sulfonated monovalent alcohol esters, such as sodium oleylisethionate; amides of amino sulfonic acids, such as the sodium salt of oleyl methyl tauride; sulfonated products of fatty acids nitriles, such as palmitonitrile sulfonate; sulfonated aromatic hydrocarbons, such as sodium alpha-naphthalene monosulfonate; condensation products of naphthalene sulfonic acids with formaldehyde; sodium octahydroanthracene sulfonate; ether sulphates having alkyl groups of 8 or more carbon atoms; alkylarylsulfonates having 1 or more alkyl groups of 8 or more carbon atoms, sodium dodecyl benzene sulfonate, dioctylsulfosuccinate, sodium polyoxyethylene lauryl ether sulfate, diphenylsulfonate derivatives, e.g., sodium dodecyl diphenyloxide disulfonate and sodium salt of tert-octylphenoxyethoxypoly(39)ethoxyethyl sulfate.

Anionic surfactants which are commercially available and useful herein include, but are not limited to, POLYSTEP™ A4, A7, A11, A15, A15-30K, A16, A16-22, A18, A13, A17, B1, B3, B5, B11, B12, B19, B20, B22, B23, B24, B25, B27, B29, C—OP3S; ALPHA-STEP™ ML40, MC48; STEPANOL™ MG; all produced by STEPAN CO., Chicago, IL; HOSTAPUR™ SAS produced by HOECHST CELANESE; HAMPOSYL^{C}30 and L30 produced by W.R. GRACE & CO., Lexington, MA.

Non-ionic surfactants include polyethoxylates, such as ethoxylated alkyl polyethylene glycol ethers; polyoxyalkylene alkyl ethers; polyoxyalkylene sorbitan esters; polyoxyalkylene esters; polyoxyalkylene alkylphenyl ethers, ethoxylated amides; ethoxylated alcohols; ethoxylated esters; polysorbate esters; polyoxypropylene compounds, such as propoxylated alcohols; ethoxylated/propoxylated block polymers and propoxylated esters; alkanolamides; amine oxides; fatty acid esters of polyhydric alcohols, such as ethylene glycol esters, diethylene glycol esters, propylene glycol esters, glyceryl esters, polyglyceryl fatty acid esters, sorbitan esters, sucrose esters and glucose esters. Commercial non-ionic surfactants include, for the sake of example, TERGITOL™ TMN-6, TERGITOL™ 15S40, TERGITOL™ 1559, TERGITOL™ 15S12, TERGITOL™ 15S15 and TERGITOL™ 15S20, and TRITON™ X405 produced by The Dow Chemical Company of Midland, Michigan; BRIJ™ 30 and BRIJ™ 35 produced by Croda (UK); MAKON™ 10 produced by STEPAN COMPANY, (Chicago, IL); and ETHOMID™ O/17 produced by Akzo Nobel Surfactants (Chicago, IL).

Amphoteric surfactants include glycinates, betaines, sultaines and alkyl aminopropionates. These include cocoamphglycinate, cocoamphocarboxy-glycinates, cocoamidopropylbetaine, lauryl betaine, cocoamidopropylhydroxysultaine, laurylsulataine and cocoamphodipropionate.

Amphoteric surfactants which are commercially available and useful herein include, for the sake of example, REWOTERIC™ AM TEG, AM DLM-35, AM B14 LS, AM CAS and AM LP produced by SHEREX CHEMICAL CO., Dublin, OH.

Cationic surfactants include aliphatic fatty amines and their derivatives, such as dodecylamine acetate, octadecylamine acetate and acetates of the amines of tallow fatty acids; homologues of aromatic amines having fatty chains, such as dodecylanalin; fatty amides derived from aliphatic diamines, such as undecylimidazoline; fatty amides derived from disubstituted amines, such as oleylaminodiethylamine; derivatives of ethylene diamine; quaternary ammonium compounds, such as tallow trimethyl ammonium chloride, dioctadecyldimethyl ammonium chloride, didodecyldimethyl ammonium chloride and dihexadecyldimethyl ammonium chloride; amide derivatives of amino alcohols, such as beta-hydroxyethylstearyl amide; amine salts of long chain fatty acids; quaternary ammonium bases derived from fatty amides of di-substituted diamines, such as oleylbenzylaminoethylene diethylamine hydrochloride; quaternary ammonium bases of the benzimidazolines, such as methylheptadecyl benzimidazole hydrobromide; basic compounds of pyridinium and its derivatives, such as cetylpyridinium chloride; sulfonium compounds, such as octadecylsulfonium methyl sulphate; quaternary ammonium compounds of betaine, such as betaine compounds of diethylamino acetic acid and octadecylchloromethyl ether; urethanes of ethylene diamine, such as the condensation products of stearic acid and diethylene triamine; polyethylene diamines and polypropanolpolyethanol amines.

Cationic surfactants which are commercially available and useful herein include, for the sake of example, ARQUAD™ T27W, ARQUAD™ 16-29, ARQUAD™ C-33. ARQUAD™ T50, ETHOQUAD™ T/13 ACETATE, all manufactured by Akzo Nobel Surfactants (Chicago, IL). The one or more surfactants (c) will usually be present in the composition herein at levels of from 0.1 wt. % to 15 wt. %, alternatively, from 0.1% to 11 wt. %, of the composition.

The foam prepared from the composition herein is either generated by mechanical means or alternatively blown physically or alternatively by both mechanical and physical means. When physical blowing is involved the composition herein additionally includes one or more physical blowing agents (d).

### Component (d): Physical Blowing Agent

When the foams herein are to be physically blown one or more physical blowing agents (d) are provided as the main source for the gas that leads to the formation of the foam. Physical blowing agents (d) undergo a phase change from a liquid to a gaseous state during exposure to atmospheric pressure and a temperature greater than or equal to (≥) 10° C., alternatively ≥20° C., alternatively≥30° C., alternatively ≥40° C., alternatively 50° C., alternatively ≥60° C., alternatively ≥70° C., alternatively ≥80° C., alternatively ≥90° C., alternatively ≥100° C. The boiling point temperature generally depends upon the particular type of physical blowing agent (d).

Useful physical blowing agents (d) include hydrocarbons, such as pentane, hexane, halogenated, more particularly chlorinated and/or fluorinated, hydrocarbons, for example dichloromethane (methylene chloride), trichloromethane (chloroform), trichloroethane, chlorofluorocarbons, hydrochlorofluorocarbons (HCFCs), ethers, ketones and esters, for example methyl formate, ethyl formate, methyl acetate or ethyl acetate, in liquid form or air, nitrogen or carbon dioxide as gases. In certain embodiments, the physical blowing agent (d) comprises a compound selected from the group consisting of propane, butane, isobutane, isobutene, isopentane, dimethylether or mixtures thereof.

In many embodiments, the blowing agent comprises a compound that is inert. These and other suitable physical blowing agents are described in U.S. Pat. Nos. 5,283,003A, 6,476,080B2, 6,599,946B2. EP3135304A1, and WO2018095760A1, which are incorporated herein by reference.

In various embodiments, the physical blowing agent (d) comprises a hydrofluorocarbon (HFC). “Hydrofluorocarbon” and “HFC” are interchangeable terms and refer to an organic compound containing hydrogen, carbon, and fluorine. The compound is substantially free of halogens other than fluorine.

Examples of suitable HFCs include aliphatic compounds such as 1,1,1,3,3-pentafluoropropane (HFC-245fa), 1,1,1,3,3-pentafluorobutane (HFC-365mfc), 1-fluorobutane, nonafluorocyclopentane, perfluoro-2-methylbutane, 1-fluorohexane, perfluoro-2,3-dimethylbutane, perfluoro-1,2-dimethylcyclobutane, perfluorohexane, perfluoroisohexane, perfluorocyclohexane, perfluoroheptane, perfluoroethylcyclohexane, perfluoro-1,3-dimethyl cyclohexane, and perfluorooctane; as well as aromatic compounds such as fluorobenzene, 1,2-difluorobenzene; 1,4-difluorobenzene. 1,3-difluorobenzene; 1,3,5-trifluorobenzene; 1,2,4,5-tetrafluorobenzene, 1,2,3,5-tetrafluorobenzene, 1,2,3,4-tetrafluorobenzene, pentafluorobenzene, hexafluorobenzene, and 1-fluro-3-(trifluoromethyl)benzene. In certain embodiments, HFC-365mfc and HFC-245fa may be preferred due to their increasing availability and ease of use, with HFC-365mfc having a higher boiling point than HFC-245fa which may be useful in certain applications. For example, HFCs having a boiling point higher than 30° C., such as HFC-365mfc, may be desirable because they do not require liquefaction during foam processing. In specific embodiments, when present, the physical blowing agents may comprise or consist of 1,1,1,3,3-pentafluoropropane (HFC-245fa).

The amount of physical blowing agent (d) utilized can vary depending on the desired outcome. For example, the amount of physical blowing agent can be varied to tailor final foam density and foam rise profile.

In certain embodiments, the composition may comprise hollow particles, which can be useful for contributing to porosity and/or overall void fraction of the foam e.g., low density (e.g., 25 kg/m³) pre-expanded polymeric spheres containing hydrocarbons having low boiling points, such that upon heating, said hydrocarbons evaporate, thereby functioning as a foaming agent leaving behind the polymeric beads. Such hollow beads are commercially available e.g., Expancel™ 920 DET 40 d25 supplied by Nouryon Chemicals.

Whilst usually deemed unnecessary in the present case, optionally, it is also possible to utilise one or more compounds comprising two or more hydrogen bonded silicon (Si—H) groups per molecule. The compound(s) comprising two or more Si—H groups per molecule which may be present in the above composition are preferably polymeric, e.g., polysilanes, polysiloxanes or a combination thereof but are preferably polysiloxanes, which may be cyclic, linear or branched, alternatively linear or branched. If each compound comprising two or more Si—H groups per molecule is a polysiloxane, the Si—H bond is on a silicon atom of an M-type or D-type siloxane unit. The polysiloxane can be linear and comprise only M type and D type units. Alternatively, the polysiloxane can be branched and contain T (SiO_{3/2}) type and/or Q (SiO_{4/2}) type units. Examples of suitable compounds comprising two or more Si—H groups per molecules include pentamethyldisiloxane, bis(trimethylsiloxy)methyl-silane, tetramethyldisiloxane, tetramethycyclotetrasiloxane, D^{H} containing poly(dimethylsiloxanes) such as DOWSIL™ MH 1107 Fluid having a viscosity of 30 mPa·s at 25° C. from Dow Silicones Corporation, and hydride terminated poly(dimethylsiloxane) such as those available from Gelest under the tradenames: DMS-HM15, DMS-H03, DMS-H25, DMS-H31, and DMS-H41.

The concentration of compounds comprising two or more Si—H groups per molecule when present is typically sufficient to provide a molar ratio of Si—H groups to epoxide groups that is greater than or equal to 0.2:1, alternatively from 0.2:1 to 5:1, alternatively 0.5:1 to 5:1, alternatively 0.5:1 to 4.5:1, alternatively 0.5:1 to 4.0:1, alternatively 0.5:1 to 3.5:1, alternatively 0.5:1 to 3.0:1, alternatively 0.5:1 to 2.5:1, alternatively 0.7:1 to 2.0:1, or alternatively 1.0:1 to 2.0:1. Either the epoxide or the compound(s) comprising two or more Si—H groups per molecule, when present, (or both) serve as crosslinkers in the reaction. When the compound(s) comprising two or more Si—H groups per molecule are present, some Si—O—C linkages will form during the curing process. However, the compound(s) comprising two or more Si—H groups per molecule, when present are not used to generate hydrogen to be used as a chemical blowing agent.

For the avoidance of doubt, it is to be understood that a crosslinker has at least two reactive groups per molecule and reacts with two different molecules through those reactive groups to cross link molecules together. Increasing the linear length between reactive groups in a crosslinker tends to increase the flexibility in the resulting crosslinked product. In contrast, shortening the linear length between reactive groups in a crosslinker tends to reduce the flexibility of a resulting crosslinked product. Generally, to achieve a more flexible crosslinked product, a linear crosslinker is desired and the length between reactive sites is selected to achieve the desired flexibility. To achieve a less flexible crosslinked product, shorter linear crosslinkers or even branched crosslinkers are desirable to reduce flexibility between crosslinked molecules.

Typically, when present, the concentration of each compound comprising two or more Si—H groups per molecule in the composition may be as high as 80 wt. % of the composition to meet the above molar ratios but when present is typically present in an amount of from 0.5 wt. % to 40 wt. %, alternatively, from 0.5 wt. % to 20 wt. % based on the weight of the composition, alternatively, from 0.5 wt. % to 15 wt. % based on the weight of the composition, alternatively from 0.5 wt. % to 10 wt. % based on the weight of the composition.

### Cure Inhibitor

The composition may also include a suitable cure inhibitor, for example a suitable amine compound, which can complex with the Lewis acid catalyst (b) to inhibit the catalytic activity thereof in the present composition over a desired temperature range but will dissociate from the Lewis acid at a desired temperature above the range so as to rapidly (within 10 minutes or less, preferably 5 minutes or less, more preferably two minutes or less) enable the composition to cure. The temperature range over which the cure inhibitor is designed to form a complex with the Lewis acid catalyst (b) and inhibit cure is dependent on the intended application for the foam product. When present the cure inhibitor is selected accordingly.

Any suitable amine may be utilised as the cure inhibitor when present. For example, the cure inhibitor(s) may include but are not limited to arylamines, e.g. triarylamines, aniline, 4-methylaniline, 4-fluoroaniline, 2-chloro-4-fluoroaniline, diphenylamine, Di(n-butyl)aniline, diphenylmethylamine, triphenylamine, 1-naphthylamine, 2-naphthylamine, 1-aminoanthracene, 2-aminoanthracene, 9-aminoanthracene, β-aminostyrene, 1,3,5-hexatrien-1-amine, N,N-dimethyl-1,3,5-hexatrien-1-amine, 3-amino-2-propenal and 4-amino-3-buten-2-one. The cure inhibitor may additionally or alternatively comprise one or more alkylamines such as, for example, butylamine, pentylamine, hexylamine, octylamine, dipropylamine, dibutylamine, dihexylamine, trimethylamine, triethylamine, tripropylamine, tributylamine, tripentylamine, trihexylamine, triheptalamine, trioctylamine and trinonylamine and/or mixtures thereof.

When present, the selection of inhibitor to be used may depend on the intended cure temperature, typically it is preferred to use arylamines for low temperature cure compositions e.g., less than 100° C. and whereas either arylamines and/or alkylamines may be used for compositions when higher temperature cure is intended e.g., for temperatures greater than about 150° C.

If component (a) has a combination of alpha-epoxide groups and cycloaliphatic epoxy groups, then the amine is desirably that suitable for the more reactive cycloaliphatic epoxide groups. Preferably, component (a) has either alpha-epoxide groups or cycloaliphatic epoxide groups and not both. When present, the concentration of cure inhibitor (amine) in the composition of the present invention is at least a molar equivalent (i.e., a molar ratio of 1:1) to the concentration of Lewis acid catalyst (b) so as to be able to complex with and inhibit all of the Lewis acid catalyst (b) at room temperature. The concentration of cure inhibitor (amine) can exceed the molar concentration of Lewis acid catalyst (b), i.e., up to about a molar ratio of 3:1 e.g., the molar ratio of the Lewis acid catalyst (b): cure inhibitor may be from 1:1 to 1:3.

In cases where the Lewis acid catalyst (b) is introduced into the composition in solution as described above, e.g. when, for the sake of example, tris(pentafluorophenyl)borane, and/or tris(3,5-bis(trifluoromethyl)phenyl) borane are used as the Lewis acid catalyst (b), if cure inhibitor is required, it may be introduced into the catalyst solution in the desired molar ratio with the Lewis acid catalyst (b) to enable a Lewis acid catalyst (b)/cure inhibitor complex to be formed in said solution before mixing with the other components. It would seem that the use of such inhibitors, particularly with respect to catalysts such as arylboranes and/or boron halides or a mixture thereof is that the catalyst/inhibitor combination can be used to tune the cure kinetics of the cure of the composition herein.

### Additional Additives

The silicone rubber foam composition as described herein may optionally further comprise additional ingredients or components (hereafter referred to as “additional additives”). Examples of additional additives include, but are not limited to, chemical blowing agents, stabilisers such as foam stabilisers (other than the surfactants of component (c) and heat stabilisers; adhesion promoters; colorants, including dyes and pigments; anti-oxidants; flame retardants; flow control additives and/or reinforcing and/or non-reinforcing (sometimes referred to as extending) fillers.

The one or more additional additives can be present in a suitable wt. % of the composition. When present the additive may be present in an amount of up to about 10 or even 15 wt. % based on the understanding that the total wt. % of the composition is 100 wt. %. One of skill in the art can readily determine a suitable amount of additional additive depending, for example, on the type of additive and the desired outcome. Certain additional additives are described in greater detail below.

Whilst suitable chemical blowing agents may be utilised as additional additives to assist in generating a foam in accordance with the above process, this is not preferred. In one preferred embodiment the composition disclosed above does not include a chemical blowing agent or compounds for generating same and/or the foam generated does not rely on a chemical blowing agent to generate the foam.

The composition disclosed above may comprise a foam stabilizer (other than component (c)) for example a silicone resin. The silicone resin (or resinous organopolysiloxane) has a branched or a three-dimensional organopolysiloxane network molecular structure. At 25° C., the resinous organopolysiloxane may be in a liquid or in a solid form, optionally dispersed in a carrier, which may solubilize and/or disperse the resin therein.

In specific embodiments, the resinous organopolysiloxane may be exemplified by an organopolysiloxane that comprises only T units, an organopolysiloxane that comprises T units in combination with other siloxy units (e.g., M, D, and/or Q siloxy units), or an organopolysiloxane comprising Q units in combination with other siloxy units (i.e., M, D, and/or T siloxy units).

Typically, the resin comprises T and/or Q units. Specific examples are alkenylated silsesquioxanes or MQ resins e.g., vinyl terminated silsesquioxanes or MQ resins.

For example, the resin may be formed from multiple groups of formula:

R⁵_{f}″SiO_{(4-f″)/2}

wherein each R⁵ is a substituted or unsubstituted monovalent hydrocarbon group of 1 to 20 carbon atoms, for example, alkyl groups such as methyl, ethyl, propyl, hexyl, octyl, dodecyl, tetradecyl, hexadecyl, and octadecyl, or an aromatic group having 6 to 20 carbons such as benzyl and phenylethyl groups or alkenyl groups such as vinyl, propenyl, n-butenyl, 1-butenyl, pentenyl, hexenyl, octenyl and the like and wherein each f″ is from 0 to 3. If the resin is a T resin, then most groups have f″ as 1 and if the resin is an MQ resin to largely comprises groups where f″ is 0 (Q groups) or 3 (M groups) as previously discussed.

The additional additives may also include pigments and/or colorants which may be added if desired. The pigments and/or colorants may be coloured, white, black, metal effect, and luminescent e.g., fluorescent and phosphorescent.

Suitable white pigments and/or colorants include titanium dioxide, zinc oxide, lead oxide, zinc sulfide, lithophone, zirconium oxide, and antimony oxide.

Suitable non-white inorganic pigments and/or colorants include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments: cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminum, copper, copper oxide, bronze, stainless steel, nickel, zinc, and brass.

Suitable organic non-white pigments and/or colorants include phthalocyanine pigments, e.g. phthalocyanine blue and phthalocyanine green; monoarylide yellow, diarylide yellow, benzimidazolone yellow, heterocyclic yellow, DAN orange, quinacridone pigments, e.g. quinacridonc magenta and quinacridonc violet; organic reds, including metallized azo reds and nonmetallized azo reds and other azo pigments, monoazo pigments, diazo pigments, azo pigment lakes, β-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

Typically, the pigments and/or colorants, when particulates, have average particle diameters in the range of from 10 nm to 50 μm, preferably in the range of from 40 nm to 2 μm. The pigments and/or colorants, when present, are present in the range of from 2, alternatively from 3, alternatively from 5 wt. % of the composition to 20, alternatively to 10 wt. % of the composition.

The additional additives include heat stabilizers which may include, for example, metal compounds such as red iron oxide, yellow iron oxide, ferric hydroxide, cerium oxide, cerium hydroxide, lanthanum oxide, copper phthalocyanine, aluminum hydroxide, fumed titanium dioxide, iron naphthenate, cerium naphthenate, cerium dimethylpolysilanolate and acetylacetone salts of a metal chosen from copper, zinc, aluminum, iron, cerium, zirconium, titanium and the like. The amount of heat stabilizer present in a composition may range from 0.01 to 1.0 wt. % of the total composition. The additional additives may also include flame retardants. Examples of flame retardants include aluminum trihydrate, magnesium hydroxide, chlorinated paraffins, hexabromocyclododecane, triphenyl phosphate, dimethyl methylphosphonate, tris(2,3-dibromopropyl) phosphate (brominated tris), and mixtures or derivatives thereof.

The additional additives may also include reinforcing and/or non-reinforcing (sometimes referred to as extending) fillers. Examples of finely divided, reinforcing fillers include high surface area fumed and precipitated silicas including rice hull ash and to a degree calcium carbonate. Examples of finely divided non-reinforcing fillers include crushed quartz, diatomaceous earths, barium sulphate, iron oxide, titanium dioxide and carbon black, talc, and wollastonite. Other fillers which might be used alone or in addition to the above include carbon nanotubes, e.g., multiwall carbon nanotubes aluminite, calcium sulphate (anhydrite), gypsum, calcium sulphate, magnesium carbonate, clays such as kaolin, aluminum trihydroxide, magnesium hydroxide (brucite), graphite, copper carbonate, e.g., malachite, nickel carbonate, e.g., zarachite, barium carbonate, e.g., witherite and/or strontium carbonate e.g. strontianite. Further alternative fillers include aluminum oxide, silicates from the group consisting of olivine group: garnet group; aluminosilicates; ring silicates; chain silicates; and sheet silicates.

The filler, if present, may optionally be surface treated with a treating agent. Treating agents and treating methods are understood in the art. The surface treatment of the filler(s) is typically performed, for example with a fatty acid or a fatty acid ester such as a stearate, or with organosilanes, organosiloxanes, or organosilazanes e.g., hexaalkyldisilazane such as hexamethyldisilazane (HMDZ) or short chain siloxane diols. Generally, the surface treatment renders the filler(s) hydrophobic and therefore easier to handle and obtain a homogeneous mixture with the other components in the composition. Silanes such as R⁷ₑSi(OR⁶)₄₋ₑ where R⁷ is a substituted or unsubstituted monovalent hydrocarbon group of 6 to 20 carbon atoms, for example, alkyl groups such as hexyl, octyl, dodecyl, tetradecyl, hexadecyl, and octadecyl, and aralkyl groups such as benzyl and phenylethyl, R⁶ is an alkyl group of 1 to 6 carbon atoms, and subscript “e” is equal to 1, 2 or 3, may also be utilized as the treating agent for fillers.

In certain embodiments, the composition may comprise hollow particles, which can be useful for contributing to porosity and/or overall void fraction of the foam e.g., low density (e.g., 25 kg/m³) pre-expanded polymeric spheres containing hydrocarbons having low boiling points, such that upon heating, said hydrocarbons evaporate, thereby functioning as a foaming agent leaving behind the polymeric beads. Such hollow beads are commercially available e.g., Expancel™ 920 DET 40 d25 supplied by Nouryon Chemicals.

For the avoidance of doubt, it is to be understood that in all other references to weight % (wt. %) of the composition in this disclosure, the total wt. % of all compositions is in all instances is 100%, with the exception of the catalyst/inhibitor which is added to the remainder of the composition which is calculated to add up to 100 wt. %.

As previously discussed, there is provided a method of making a silicone rubber foam comprising:
mixing a silicone rubber foam composition comprising
(a) one or more organopolysiloxane polymers having an average of at least two epoxide groups per molecule;
(b) a Lewis acid catalyst;
(c) one or more surfactants; and
either mechanically foaming the above composition: or
introducing (d) a physical blowing agent; and causing foaming by means of said physical blowing agent (d), in each case whilst the composition cures.

As previously indicated the above composition may optionally comprise a physical blowing agent, a cure inhibitor or both a physical blowing agent and a cure inhibitor as well as numerous additional additives utilised dependent on the application for which the foam is to be used. When both a physical blowing agent and a cure inhibitor, the temperature at which the physical blowing agent becomes gaseous may be lower, approximately the same or higher than the temperature at which point the cure/inhibitor complex breaks down allowing cure to commence. In one embodiment the temperature may be approximately the same (e.g., within 15° C. of each other).

Mechanical foaming or foaming caused by the physical blowing agent (d) occurs before and/or during cure.

In one embodiment, the process may comprise the steps of

Preparing a Lewis acid catalyst (b) solution by mixing the catalyst in a suitable solvent or combination of solvents, or if the optional cure inhibitor, e.g. one or more amines as previously described, is present in the composition, preparing a Lewis acid catalyst (b)/cure inhibitor complex solution by mixing the catalyst and inhibitor in a suitable molar ratio in a suitable solvent or combination of solvents, as described above, to form the Lewis acid catalyst (b)/cure inhibitor complex solution; then
providing a composition of the present invention; and mixing said catalyst solution or Lewis acid catalyst (b)/cure inhibitor complex solution with components (a), (c), (d) and to form a silicone rubber foam composition.

Alternatively, when the cure inhibitor (e.g., amine) is present, it is possible to prepare the Lewis acid catalyst (b)/cure inhibitor complex in the presence of the other components of the composition provided the Lewis acid does not catalyze the reaction prior to complex formation. When present the cure inhibitor enhances shelf stability of the composition, typically at low temperatures e.g., room temperature and the selection of cure inhibitor and catalyst (b) can be utilised to tune an approximate elevated temperature above which the composition will cure after the breakdown of the catalyst (b)/cure inhibitor complex. This temperature may pre-determined based on the application for which the foam is to be used and may, for the sake of example, be 50° C. or 60° C. or 80° C. or higher.

During preparation of the composition the components of the composition can be introduced in any suitable order into a suitable container and mixed using a suitable mixer for a predetermined period of time to homogenize the composition. Such a mixer may be a speedmixer or the like.

Subsequently, in the case of mechanical foaming the prepared composition is introduced into a suitable type of agitation system which can be utilized to beat air into the silicone composition to cause mechanical foaming. Any suitable type of mechanical mixing equipment can be utilized to introduce air and create the foam e.g., a portable rotor stator which may be utilised given the ability for dynamic and high shear mixing and generating heat as well as the ability to agitate and incorporate air into the composition and thereby cause foaming. When the cure inhibitor is present and has formed a complex with the Lewis acid catalyst (b), the ability to heat is important as the sample can be heated up quickly to initiate the cure reaction so that the mixture becomes viscous enough to hold bubbles. In the case of physically blown foams the composition may be mixed together in any suitable order although the Lewis acid catalyst (b) and physical blowing agent (d) are typically introduced into the composition as the last two components. Once the physical blowing agent (d) has been added, usually in liquid form, mixing continues and the temperature is raised up to the temperature where the liquid physical blowing agent (d) turns gaseous and causes foaming during cure of the composition.

The silicone rubber foam compositions as described herein produce open cell and/or closed cell silicone rubber foams. The foam density may be measured by any suitable method such as via the Archimedes principle, using a balance and density kit, and following standard instructions associated therewith. A suitable balance is a Mettler-Toledo XS205DU balance with density kit. The foam may have a density of from 0.01 grams per cubic centimeter g/cm³ to 5 g/cm³, alternatively from 0.05 g/cm³ to 2.5 g/cm³ alternatively from 0.1 g/cm³ to 2.0 g/cm³, alternatively from 0.1 g/cm³ to 1.5 g/cm³.

If the density is too high, the foam may be too heavy or stiff for certain applications. If density is too low, the foam may lack desired structural integrity for certain applications.

The average pore size can be determined via any suitable method such as in accordance with ATSM method D3576-15 optionally with the following modifications:
(1) image a foam using optical or electron microscopy rather than projecting the image on a screen; and
(2) scribe a line of known length that spans greater than 15 cells rather than scribing a 30 mm line.

The silicone foam compositions as described herein generally have pores that are uniform in size and/or shape. Typically, the foam has an average pore size of between 0.001 mm and 5 mm, alternatively between 0.001 mm and 2.5 mm, alternatively between 0.001 mm and 1 mm, alternatively between 0.001 mm and 0.5 mm, alternatively between 0.001 mm and 0.25 mm, alternatively between 0.001 mm and 0.1 mm, and alternatively between 0.001 mm and 0.05 mm.

The compositions, foams, and methods described herein are useful for a variety of end applications and are not limited to any particular one. Examples of suitable applications include space filling applications, automotive applications (e.g., for control modules), and the like. The foams can be used to at least partially cover or encapsulate articles, such as batteries and other electronic components. The foams can also be used for thermal insulation. The foams can be formed in environments where the formation of chemical blowing agents e.g., hydrogen gas is a concern. In addition, the foams can be foamed at room temperature or thereabout, which is useful for temperature sensitive applications.

### EXAMPLES

Four organopolysiloxane polymers having an average of at least two epoxide groups per molecule were prepared in the laboratory.

### Synthesis of Epoxycyclohexylethyl Terminated Polydimethylsiloxane, M^{CEP}D₄₀M^{CEP}

To a 500 mL 3-neck dry flask were added 100 g (0.06464 mol) M^{H}D₄₀M^{H}, 2 ppm Pt (Karstedt's catalyst) and 80 mL toluene. The mixture was then heated to 80° C. 12 g (0.097 mol) 1,2-epoxy-4-vinylcyclohexane in 20 mL toluene was added dropwise within 25 min at 80° C., and then the reaction mixture was heated to reflux (at about 110° C.) for 6 h.

Sampling to NMR showed the completion of the reaction, and then the solvent and excess 1,2-epoxy-4-vinylcyclohexane were removed using a rotary evaporator to obtain 103 g the product M^{CEP}D₄₀M^{CEP} with 95% yield.

### Synthesis of (epoxycyclohexylethyl)methylsiloxane-dimethylsiloxane copolymer, MD₆₀D^{CEP}_{7.6}M

To a 500 mL 3-neck dry flask were added 110.7 g (0.163 mol SiH) MD_{60.5}D^{H}_{7.6}M. 2 ppm Pt (Karstedt's catalyst) and 80 g toluene. The mixture was then heated to 80° C. 30.4 g (0.245 mol) 1,2-epoxy-4-vinylcyclohexane in 30 g toluene was added dropwise within 30 min at 80° C., and then the reaction mixture was heated to reflux (at about 110° C.) for 6 h. Sampling to NMR showed the completion of the reaction, and then the solvent and excess 1,2-epoxy-4-vinylcyclohexane were removed using a rotary evaporator to obtain 127 g the product MD_{60.5}D^{CEP}_{7.5}M with 90% yield.

### Synthesis of epoxycyclohexylethyl terminated polydimethylsiloxane, M^{CEP}D₃₇₆M^{CEP}

To a 1000 mL 3-neck dry flask were added 300 g (0.02143 mol SiH) M^{H}D₃₇₆M^{H}, 2 ppm Pt (Karstedt's catalyst) and 200 mL toluene. The mixture was then heated to 80° C. 4 g (0.03214 mol) 1,2-epoxy-4-vinyl-cyclohexane in 10 mL toluene was added dropwise within 20 min at 80° C., and then the reaction mixture was heated to reflux (at about 110° C.) for 6 h.

Sampling to NMR showed the completion of the reaction, and then the solvent and excess 1,2-epoxy-4-vinylcyclohexane were removed using a rotary evaporator to obtain 277 g the product M^{CEP}D₄₀M^{CEP} with 91% yield.

### Synthesis of (epoxycyclohexylethyl)methylsiloxane-dimethylsiloxane copolymer, MD₂₃₃D^{CEP}_{8.5}M

To a 1000 mL 3-neck dry flask were added 200 g (0.095 mol SiH) MD₂₃₃D^{H}_{8.5}M, 2 ppm Pt (Karstedt's catalyst) and 150 mL toluene. The mixture was then heated to 80° C. 14.2 g (0.114 mol) 1,2-epoxy-4-vinyl-cyclohexane in 10 mL toluene was added dropwise within 20 min at 80° C., and then the reaction mixture was heated to reflux (at about 110° C.) for 6 h.

Sampling to NMR showed the completion of the reaction, and then the solvent and excess 1,2-epoxy-4-vinylcyclohexane were removed using a rotary evaporator to obtain 198 g the product MD₂₃₃D^{CEP}_{8.5}M with 92% yield.

The four organopolysiloxane polymers having an average of at least two epoxy groups per molecule produced were each then incorporated into a silicone rubber foam composition as depicted in Table 1a below (wt. % excluding catalyst/cure inhibitor complex solution (Ex. 1-5) which are dealt with in Table 1b. All viscosities are measured at 25° C. relying on the cup/spindle method of ASTM D1084-16 Method B, using the most appropriate spindle for the viscosity range unless otherwise indicated.

TABLE 1a
Silicone rubber foam compositions (Ex. 1 to Ex. 5) (catalyst/cure
inhibitor complex solution solutions)

| Ingredient | Ex. 1 | Ex. 2 | Ex. 3 | Ex. 4 | Ex. 5 |
|---|---|---|---|---|---|
| MD₆₀D^{CEP}_{7.6}M (wt. %) | — | — | 86.0 | — | 45.0 |
| MD₂₃₃D^{CEP}_{8.5}M (wt. %) | — | — | — | 86.0 | — |
| M^{CEP}D₃₇₆M^{CEP} (wt. %) | — | — | — | — | 41.0 |
| M^{CEP}D₄₀M^{CEP} (wt. %) | 94.0 | 88.8 | — | — | — |
| DOWSIL ™ MH 1107 Fluid (wt. %) | — | 5.2 | — | — | — |
| Surfactant (wt. %) | 6 | 6 | 6 | 6 | 6 |
| 1,1,1,3,3-Pentafluoropropane | — | — | 8 | 8 | 8 |
| (HFC-245fa) (wt. %) | | | | | |

In all the examples (Ex. 1 to 5) di(n-butyl)aniline, (PhNH(n-C₄H₉)₂) was used as a cure inhibitor. The Lewis acid catalyst (b)/cure inhibitor complex solution was prepared by dissolving designated amounts of the selected catalyst and cure inhibitor Di(n-butyl)aniline (PhNH(n-C₄H₉)₂) (often referred to as DBA) in toluene. Consequently, the solution introduced into the remaining composition was a Lewis acid catalyst (b)/inhibitor complex solution which, when mixed into the composition would inhibit catalytic activity until heated.

TABLE 1b
Catalyst concentration introduced in toluene solution and
inhibitor:Lewis acid catalyst (b) molar ratio when di(n-butyl)aniline, (PhNH(n-
C₄H₉)₂) was used as a cure inhibitor

| Ingredient | Ex. 1 | Ex. 2 | Ex. 3 | Ex. 4 | Ex. 5 |
|---|---|---|---|---|---|
| Tris(pentafluorophenyl)borane (B(C₆F₅)₃) (ppm) | 100 | 100 | 400 | — | 500 |
| Tris(3,5-bis(trifluoromethyl)phenyl)borane (ppm) | — | — | — | 400 | — |
| Inhibitor/catalyst molar ratio | 2:1 | 2:1 | 2:1 | 2:1 | 2:1 |

The surfactant used in the present examples was a commercial surfactant sold as DOWSIL™ 3-9727 Profoamer by Dow Silicones Corporation of Midland Michigan.

DOWSIL™ MH 1107 Fluid is a trimethyl terminated polymethylhydrogen siloxane having a viscosity of about 30 mPa·s at 25° C. (data sheet value) commercially available from Dow Silicones Corporation.

The compositions depicted in Table 1 were mixed and mechanically foamed (frothed) for Ex. 1 and Ex. 2.

### Preparation of Mechanically Frothed Foams (Ex. 1-2)

The Lewis acid catalyst (b)/cure inhibitor complex solution, surfactant (c), optional SiH-functionalized silicone (when present), and component (a) were added in sequence to a speedmix cup, which was subsequently speed-mixed at 3000 rpm for 30 s. A portable rotor stator was used for its dynamic and high shear mixing to agitate air into the liquid formulation and generate heat. Rapid plunging was used to incorporate air and heat the sample up fast to initiate the cure reaction until the mixture was viscous enough to hold bubbles. The mechanical foaming i.e., rapid plunging was carried out for a period of approximately 2-3 minutes before the composition was cured almost immediately after the plunging process ceased. The final temperature of the composition when cured was about 50° C.

### Preparation of Physically Blown Foams (Ex. 3-5)

For Ex. 3, 4 and 5 the composition was mixed and physically blown using physical blowing agent 1,1,1,3,3-Pentafluoropropane (HFC-245fa).

For Examples 3-5, the surfactant (c) and component (a) were added to a speedmix cup, which was subsequently speed mixed at 3000 rpm for 30 s. After addition of the Lewis acid catalyst (b)/cure inhibitor complex solution and a slight excess of liquid physical blowing agent (d) liquid, the mixture was hand mixed for 1-2 min at room temperature and then cured. In this case the boiling point of the blowing agent is about 15° C. It was stored as a liquid in the freezer at about −4° C. until the time of introduction and as such when added to the rest of the composition the actual temperature of the blowing agent was below room temperature. Hence, additional heating was unnecessary.

TABLE 2
Comparative Example 1 - a 2-part platinum-
cured silicone foam composition

| | Part A | Part B |
|---|---|---|
| Component | (wt. %) | (wt. %) |
| Vinyldimethyl terminated polydimethylsiloxane | 58.8 | 62.7 |
| viscosity about 450 mPa · s | | |
| Vinyldimethyl terminated polydimethylsiloxane | 19.1 | 0 |
| viscosity about 40,000 mPa · s | | |
| A mixture of Karstedt's Catalyst in a vinyldimethyl | 0.2 | 0 |
| terminated polydimethylsiloxane said mixture | | |
| having a viscosity of about 400 mPa · s | | |
| Surfactant | 9.4 | 0 |
| 1,1,1,3,3-Pentafluoropropane (HFC-245fa) | 12.5 | 0 |
| A blend of 74.5 wt. % Vinyldimethyl terminated | 0 | 34.1 |
| polydimethylsiloxane viscosity about 55,000 | | |
| mPa · s with 25.5 wt. % of vinyl functional | | |
| MQ resin containing about 2 wt. % vinyl | | |
| DOWSIL ™ MH 1107 Fluid (wt. %) | 0 | 3.2 |

All viscosities are measured at 25° C. relying on the cup/spindle method of ASTM D₁₀₈₄-16 Method B, using the most appropriate spindle for the viscosity range unless otherwise indicated.

### Preparation of Pt-Catalyzed Physically Blown Foam (C. 1)

The composition of Table 2 was a two-part composition (part A and part B) which were first individually prepared and kept separate during storage. The components of Parts A excluding the surfactant and blowing agent were first mixed in speedmixer at 3000 rpm for 20 s. The surfactant and blowing agent were subsequently added to Part A, similarly The components of Parts B were first mixed in speedmixer at 3000 rpm for 20 s. Part B was then added to Part A in a 1:1 weight ratio and the formulation was mixed thoroughly with spatula for 30 s. Foaming was allowed to take place in the same container in which the components were mixed or poured together.

The “curing” event was characterized by snap time, wherein a tongue depressor was depressed upon the foam and no material was observed to be adherent to the tongue depressor. The foams were allowed to sit for 24 hours before further characterization.

The compositions described herein and depicted in the examples provide foams without the need to use flammable physical blowing agents like hydrogen. This provides a much safer way of generating silicone foams than the previously relied upon silicone foams that were chemically blown by the generation of flammable hydrogen gas. When compared with incumbent Pt-catalyzed physically blown foam (C. 1), the densities of our foams are slightly higher and can be further reduced if a larger amount of physical blowing agent is used.

### Measurement Information

The cure time given in the following Tables for each foam and the foam density values were determined using the following test methods.

### Cure Time Measurement

The cure times of compositions ((Ex. 1-3 and 5)) were measured by oscillatory rheological tests on a stress-controlled rotational rheometer (AR-G2, TA Instruments) using a 25 mm parallel-plate geometry. A certain oscillatory stress depending on the sample's linear viscoelastic regime was applied at an angular frequency of 1 rad/s as the sample was heated at 25° C. (Ex. 3 and 5) or 50° C. (Ex. 1-2). The oscillatory stress was programmed to increase to 1000 Pa when the displacement was too low for a good signal-to-noise (S/N) ratio. The cure time was defined by the crossover point of shear storage and loss moduli.

### Density Measurement

Foam densities were measured using a balance (Mettler-Toledo XS205DU) equipped with a density measurement kit based on Archimedes' principle. The weight of a sample (m₀) in air was first measured, after which the balance was tared without removing the sample. The weight of the sample (−m₁) in water (ρ₀=1 g/cc) was then measured.

$$ρ = \frac{{m}_{0}}{- {m}_{1}} \times {ρ}_{0}$$

The results from the above together with details of the foam morphology was noted for each foam generated are depicted below in Table 3.

TABLE 3
Physical Properties

| Tested Property | Ex. 1 | Ex. 2 | Ex. 3 | Ex. 4 | Ex. 5 | C. 1 |
|---|---|---|---|---|---|---|
| Cure time at 25° C. (min) | — | — | 2.2 | — | 1.6 | 4.0 |
| Cure time at 50° C. (min) | 2.7 | 4.4 | — | — | — | |
| Density (g/cc) | 0.90 | 0.88 | 0.70 | 0.46 | 0.63 | 0.44 |
| Foam morphology (closed or open | Closed | Closed | Closed | Closed | Mixed | Closed |
| cells) | | | | | | |

The results demonstrated that silicone foams that do not contain any organics in the backbone could be prepared using Lewis acid-catalyzed reactions. Specifically, as demonstrated in Ex. 5, a mixture of one or more organopolysiloxane polymers having an average of at least two epoxide groups per molecule could also be used for silicone foam preparation.

The compositions described herein and depicted in the examples provide foams without the need to use flammable physical blowing agents like hydrogen. This provides a much safer way of generating silicone foams than the previously relied upon silicone foams that were chemically blown by the generation of flammable hydrogen gas. When compared with comparative example 1 incumbent the densities of the Ex. 1 to 5 foams are slightly higher and can be further reduced if a larger amount of the physical blowing agent liquid is used.

1. A silicone rubber foam composition comprising:
(a) one or more organopolysiloxane polymers having an average of at least two epoxide groups per molecule;
(b) a Lewis acid catalyst;
(c) one or more surfactants; and optionally
(d) a physical blowing agent.

2. The silicone rubber foam composition in accordance with claim 1, wherein each epoxide group of component (a) is an alpha-epoxide group or a cycloaliphatic epoxide group and in each case linked by way of an alkylene chain or a substituted alkylene chain comprising an optional ether linkage to a silicon from an organopolysiloxane polymer.

3. The silicone rubber foam composition in accordance with claim 1, wherein component (a) the one or more organopolysiloxane polymers having an average of at least two epoxide groups per molecule is selected from at least one of the following:
MDₐD^{CEP}_{b}M
MDₐD^{EP}_{b}M
M^{CEP}D_{c}M^{CEP}
M^{EP}D_{c}M^{EP}
D^{EP}_{b}D_{c}T₂
D^{CEP}_{b}D_{c}T₂
where M-type siloxy units are ≡SiO_{1/2} where there are three groups bound to the silicon atom in addition to an oxygen atom that is shared with another atom linked to the siloxy group; D-type siloxy units are ═SiO_{2/2} where there are two groups bound to the silicon atom in addition to two oxygen atoms that are shared with other atoms linked to the siloxy group; T-type siloxy units are —SiO_{3/2} where one group is bound to the silicon atom in addition to three oxygen atoms; superscript, CEP indicates that the respective M or D unit has a cycloaliphatic epoxide linked to it; superscript EP indicates that the respective M or D unit has an alpha-epoxide linked to it; subscript a has a value of from 10 to about 300; subscript b has a value of from 1 to 30; and subscript c has a value of from 5 to 500.

4. The silicone rubber foam composition in accordance with claim 1, wherein component (b) the Lewis acid catalyst comprises one or more arylboranes or boron halides or a mixture thereof.

5. The silicone rubber foam composition in accordance with claim 1, wherein component (b) the Lewis acid catalyst is selected from tris(pentafluorophenyl)borane, tris(3,5-bis(trifluoromethyl)phenyl)borane, bis(3,5-bis(trifluoromethyl)phenyl)(4-(trifluoromethyl)phenyl)borane, bis(3,5-bis(trifluoromethyl)phenyl)(2,4,6-trifluorophenyl)borane or a mixture thereof.

6. The silicone rubber foam composition in accordance with claim 1, wherein component (c) the one or more surfactants is a silicone fluorinated surfactant or an organic fluorinated surfactant.

7. The silicone rubber foam composition in accordance with claim 1, wherein component (d) the physical blowing agent is present and is selected from an alkane, a chlorinated hydrocarbon, hydrofluorocarbon (HFC), chlorofluorocarbons, hydrochlorofluorocarbons (HCFCs), ethers, ketones and esters.

8. The silicone rubber foam composition in accordance with claim 1, comprising one or more compounds comprising two or more hydrogen bonded silicon (Si—H) groups per molecule, one or more cure inhibitors or a mixture thereof.

9. The silicone rubber foam composition in accordance with claim 8, wherein the cure inhibitor is present and is selected from one or more arylamines and/or alkylamines.

10. The silicone rubber foam composition in accordance with claim 9, comprising one or more cure inhibitors selected from triarylamines aniline, 4-methylaniline, 4-fluoroaniline, 2-chloro-4-fluoroaniline, diphenylamine, diphenylmethylamine, triphenylamine, 1-naphthylamine, 2-naphthylamine, 1-aminoanthracene, 2-aminoanthracene, 9-aminoanthracene, β-aminostyrene, 1,3,5-hexatrien-1-amine, N,N-dimethyl-1,3,5-hexatrien-1-amine, 3-amino-2-propenal, 4-amino-3-buten-2-one, trimethylamine, triethylamine, tripropylamine, tributylamine, tripentylamine, trihexylamine, triheptalamine, trioctylamine and trinonylamine, butylamine, pentylamine, hexylamine, octylamine, dipropylamine, dibutylamine, dihexylamine, trimethylamine, triheptylamine, and/or mixtures thereof.

11. The silicone rubber foam composition in accordance with claim 1, comprising one or more additional additives selected from foam stabilizers, adhesion promoters; colorants, dyes and pigments; anti-oxidants; heat stabilizers; flame retardants; flow control additives and/or reinforcing and/or non-reinforcing fillers.

12. A silicone rubber foam which is a foamed and cured product of the composition in accordance with claim 1.

13. The silicone rubber foam in accordance with claim 12 having a density of less than 1 g/cm³.

14. A method of making a silicone rubber foam, the method comprising:
mixing a silicone rubber foam composition comprising
(a) one or more organopolysiloxane polymers having an average of at least two epoxide groups per molecule;
(b) a Lewis acid catalyst;
(c) one or more surfactants; and
either
mechanically foaming the above composition; or
introducing (d) a physical blowing agent; and causing foaming by means of the physical blowing agent (d);
in each case while the composition cures.

15. (canceled)
